(19) United States
(12) Patent Application Publication
(10) Pub. No.: US 2021/0065570 A1
(43) Pub. Date: Mar. 4, 2021

(54) Systems and methods for facilitating learning through interaction with objects in an environment

(71) Applicant: Talkiwear Pty Ltd, Alphington (AU)

(72) Inventor: Annie Kathleen MCAULEY, Victoria (AU)

(21) Appl. No.: 17/096,029

(22) Filed: Nov. 12, 2020

Related U.S. Application Data
(63) Continuation of application No. PCT/AU2018/051299, filed on Dec. 5, 2018.

(30) Foreign Application Priority Data
May 12, 2018 (AU) 2018901683

(51) Int. Cl. G09B 5/08; G09B 25/00; G09B 23/00; G06K 19/07; G06K 19/077

(52) U.S. Cl. CPC G09B 5/08; G09B 25/00; G06F 21/31; G06K 19/0716; G06K 19/07758; G09B 23/00

(57) ABSTRACT

Embodiments generally relate to a computer implemented method of facilitating learning, the method comprising receiving, at a computing device, data indicative of a user profile, the user profile being associated with a user level; receiving, at a computing device, data indicative of user interaction with an identification tag, wherein the data comprises an identification code; identifying an object type associated with the identification code; determining an interaction response level based on the user level associated with the user profile; determining a response to be delivered to the user based on the object type and the interaction response level; and causing the response to be delivered to the user.

### TECHNICAL FIELD

Embodiments generally relate to systems and methods for facilitating learning through interaction with objects in an environment. In particular, embodiments relate to facilitating learning through visual, oral and aural interaction with objects in an environment.

### BACKGROUND

Teaching children languages and other skills is important for their development and growth, but can be limited by the amount of time instructors, such as parents and teachers, have available to facilitate that teaching. Many parents struggle to spend enough time engaging in interactive learning with their children, and teachers may not be able to give a child one-on-one attention in a busy classroom. Learning tools such as toys and books can be given to children to provide some educational benefit, but these tools lack contact based learning associations and the interaction that children can get from other human beings.

It is desired to address or ameliorate one or more shortcomings or disadvantages associated with prior systems and methods for providing interactive context based learning to children, or to at least provide a useful alternative thereto.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each of the appended claims.

### SUMMARY

Some embodiments relate to a computer implemented method of facilitating learning, the method comprising:
receiving, at a computing device, data indicative of a user profile, the user profile being associated with a user level;
receiving, at a computing device, data indicative of user interaction with an identification tag, wherein the data comprises an identification code;
identifying an object type associated with the identification code;
determining an interaction response level based on the user level associated with the user profile;
determining a response to be delivered to the user based on the object type and the interaction response level; and
causing the response to be delivered to the user.

In some embodiments, receiving data indicative of a user profile comprises receiving user credentials entered by a user during a login process. In some embodiments, the user profile is a default user profile, the user profile being associated with a default user level.

According to some embodiments, receiving data indicative of user interaction with an identification tag comprises receiving data from a sensor component of the computing device. In some embodiments, receiving data indicative of user interaction with an identification tag comprises receiving data from a sensor device external to the computing device, the sensor device comprising a sensor component.

In some embodiments, receiving data indicative of user interaction with an identification tag comprises receiving data indicative of the sensor component being in proximity to the identification tag. According to some embodiments, the identification tag is a near field communication (NFC) tag.

In some embodiments, causing the response to be delivered to the user comprises transmitting the response to the user from an output component of the computing device. According to some embodiments, causing the response to be delivered to the user comprises transmitting the response to an output device external to the computing device.

Some embodiments further comprise, before determining a response to be delivered to the user, modifying the interaction response level based on interaction history data retrieved from a database.

According to some embodiments, the object type is identified based on matching the identification code to an identification code stored in a database of associated identification codes and object types.

Some embodiments further comprise:
identifying whether the response to be delivered includes a variable field; and
if the response to be delivered includes a variable field, retrieving appropriate data to insert into the variable field, to complete the response.

Some embodiments further comprise:
determining that a further interaction has occurred; and
generating a further response and causing the response to be delivered

In some embodiments, determining that a further interaction has occurred comprises receiving a signal from a sensor component of the computing device. According to some embodiments, determining that a further interaction has occurred comprises receiving a signal from a sensor device external to the computing device, the sensor device comprising a sensor component.

According to some embodiments, determining that a further interaction has occurred comprises determining that the sensor component is in proximity to the identification tag. In some embodiments, determining that a further interaction has occurred comprises receiving a user input signal from a user input component of at least one of the computing device and the sensor device.

Some embodiments relate to a computing device for facilitating learning, the computing device comprising:
a processor; and
memory accessible to the processor and storing executable code, wherein when the executable code is executed by the processor, the processor is caused to:
receive data indicative of a user profile, the user profile being associated with a user level;
receive data indicative of user interaction with an identification tag, wherein the data comprises an identification code;
identify an object type associated with the identification code;
determine an interaction response level based on the user level associated with the user profile;
determine a response to be delivered to the user based on the object type and the interaction response level; and
causing the response to be delivered to the user.

Some embodiments further comprise a communications module configured to facilitate communications between the computing device and at least one external device.

In some embodiments, the communications module is configured to facilitate communications between the computing device and a sensor device, and wherein the computing device is configured to receive data indicative of user interaction with the identification tag from the sensor device. Some embodiments comprise a tag sensor module, wherein the computing device is configured to receive data indicative of user interaction with the identification tag from the tag sensor module.

Some embodiments further comprise an output module, wherein the computing device causes the response to be delivered to the user by outputting the response via the output module. In some embodiments, the communications module is configured to facilitate communications between the computing device and a media device, and wherein the computing device causes the response to be delivered to the user by communicating the response to the media device.

According to some embodiments, the communications module is configured to facilitate communications between the computing device and a cloud server, and wherein the computing device determines a response to be delivered based on the object type and the interaction response level by communicating the object type and the interaction response level to the cloud server, and receiving a response to be delivered from the cloud server.

Some embodiments comprise a kit for facilitating learning via interaction with objects in an environment; the kit comprising:
at least one identification tag comprising an identification code;
a sensor device configured to read the identification code of the at least one identification tag and communicate the identification code to a computing device; and
at least one media device configured to receive output media from the computing device and to deliver the output media to a user.

Some embodiments comprise a kit for facilitating learning via interaction with objects in an environment; the kit comprising:
at least one identification tag comprising an identification code; and
a device configured to read the identification code of the at least one identification tag and communicate the identification code to a computing device, and to receive output media from the computing device and to deliver the output media to a user.

### BRIEF DESCRIPTION OF DRAWINGS

Embodiments are described in further detail below, by way of example and with reference to the accompanying drawings, in which:

FIG. 1 shows a block diagram of an interactive learning system, according to some embodiments;

FIG. 2 shows a block diagram of an interactive learning system, according to some alternative embodiments;

FIG. 3 shows a block diagram of an interactive learning system, according to some alternative embodiments;

FIG. 4 shows a block diagram of an interactive learning system, according to some alternative embodiments;

FIG. 5 shows a flowchart illustrating a method of facilitating interactive learning, as performed by a computing device of the interactive learning system of FIG. 1;

FIG. 6 shows a flowchart illustrating a method of facilitating interactive learning, as performed by a cloud server of the interactive learning system of FIG. 1; and

FIG. 7 shows a diagram illustrating the interactive learning system of FIG. 1 in use.

### DETAILED DESCRIPTION

Embodiments generally relate to systems and methods for facilitating learning through interaction with objects in an environment. In particular, embodiments relate to facilitating learning through visual, oral and aural interaction with objects in an environment.

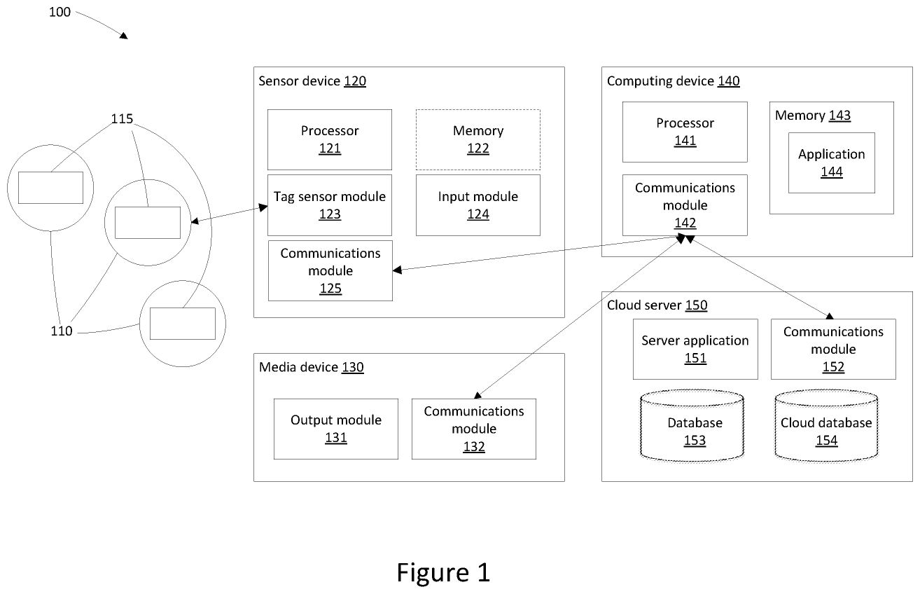

FIG. 1 shows a block diagram of an interactive system 100 for providing interactive learning experiences to a subject. System 100 is configured to provide active and interactive learning experiences by delivering educational content to a subject in context with the subject's environment.

System 100 includes at least one ID tag 110 and a sensor device 120 configured to communicate with the at least one ID tag 110. System 100 also includes a computing device 140 in communication with sensor device 120. Computing device 140 is also in communication with a media device 130, and a cloud server 150.

In FIG. 1, three ID tags 110 are shown. However, system 100 may include one or more ID tags 110, including but not limited to 1, 2, 3, 4, 5, 6, 7, 8, 9 or 10 ID tags 110. ID tags 110 may store an identification code 115 that can be read by sensor device 120. Each ID tag 110 may have an individual and unique identification code 115. In some alternative embodiments, an identification code 115 may be shared by more than one ID tag 110. In some embodiments, each ID tag 110 may have an identification code 115 selected from a set of identification codes 115 stored in cloud server 150.

Each identification code 115 may be associated with an object or location type. In some embodiments, object types may be associated with everyday objects and furniture found in the average home, such as table, chair, window, bed or bath, for example. Location types may be associated with areas or rooms common to an average home, such as kitchen, bedroom, bathroom, living room or play room, for example.

In use, ID tags 110 may be installed in a home, school, or other environment, with each ID tag being located on or in close proximity to the object or in the location with which it is associated. For example, a “table” type ID tag 110 may be located on or in close proximity to a table. A “bathroom” type ID tag 110 may be located in a bathroom or in close proximity to a bathroom, for example, on a bathroom door.

In some embodiments, ID tags 110 may be associated with persons, such as mum, dad, brother, sister, grandmother, grandfather, teacher, doctor, for example.

In some embodiments, ID tags 110 may be near field communication (NFC) tags, and identification codes 115 may be configured to be readable by an NFC reader device. In some embodiments, identification codes 115 may be visual codes such as barcodes or QR codes; magnetic tags; Bluetooth beacons, Wi-Fi enabled devices, infra-red readable codes, or another type of code carrying data capable of being read by sensor device 120 using contact based or contactless communication. In some embodiments, identification code 115 may be written to ID tag 110 when each tag 110 is initialised during manufacture, and may be a permanent or persistent identification code that is un-editable and un-rewritable. In some alternative embodiments, data such as the identification code may be edited and written to ID tags 110 during their lifetime.

Referring again to FIG. 1, sensor device 120 comprises a processor 121 and optionally memory 122. In some embodiments, sensor device 120 may not comprise any memory 122, and may instead be configured to automatically communicate any captured data to computing device 140. In some embodiments, sensor device 120 may comprise a contactless smart card reader, which may be a PC-linked contactless smart card reader, such as the ACR122U NFC Reader by Advanced Card Systems Ltd.

Where sensor device 120 does comprise memory 122, processor 121 may be configured to access data stored in memory 122, to execute instructions stored in memory 122, and to read and write data to and from memory 122. Processor 121 may comprise one or more microprocessors, central processing units (CPUs), application specific instruction set processors (ASIPs), or other processor capable of reading and executing instruction code. Memory 122 may comprise one or more volatile or non-volatile memory types, such as RAM, ROM, EEPROM, or flash, for example.

Processor 121 may be configured to communicate with one or more peripheral devices via one or more input and/or output modules. In some embodiments, processor 121 may be in communication with a tag sensor module 123 of the sensor device 120. Tag sensor module 123 may be a sensor component configured to read identification codes 115 from ID tags 110, and communicate the read data to processor 121. Tag sensor module 123 may comprise one or more of an NFC reader, magnetic code reader, camera, or laser scanner, or may be otherwise configured to allow tag sensor module 123 to read identification code 115. In some embodiments, tag sensor module 123 may be configured to only read identification codes 115 from tags 110 that are in proximity with sensor device 120. For example, in some embodiments, tag sensor module 123 may be configured to read identification codes 115 from ID tags 110 that are within 10 cm of sensor device 120. In some embodiments, tag sensor module 123 may be configured to read identification codes 115 from ID tags 110 that are within 5 cm of sensor device 120.

Processor 121 may also be in communication with an input module 124, which may be configured to receive user input, and send the received user input to processor 121. For example, input module 124 may receive input from one or more of a touch screen display, a microphone, a camera, a button, a dial or a switch.

Furthermore, processor 121 may be in communication with a communications module 125, which may be configured to allow sensor device 120 to communicate with external devices such as computing device 140. Communications module 125 may be configured to facilitate communication via a wired or wireless communication protocol, which may include Bluetooth, Wi-Fi, Ethernet, USB, and/or any other communication protocols.

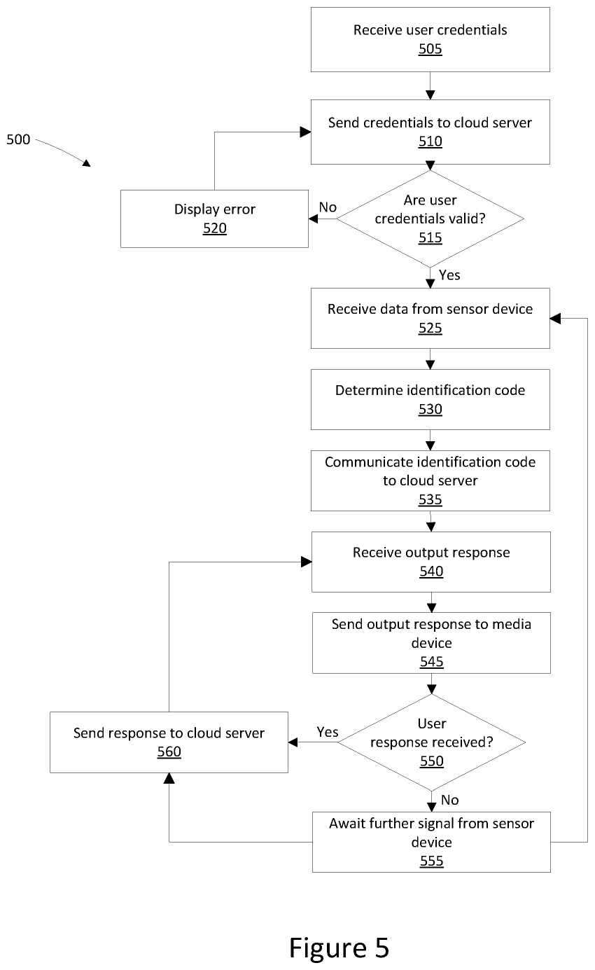

In use, when sensor device 120, or tag sensor module 123, comes into proximity with an ID tag 110, processor 121 may execute instruction code stored in memory 122 to cause processor 121 to instruct tag sensor module 123 to read identification code 115. Processor 121 may receive identification code 115 from tag sensor module 123, and communicate identification code 115 to computing device 140 via communications module 125. This may cause computing device 140 to communicate with media device 130, to cause an output response to be delivered to the user. If computing device 140 responds with a message to indicate that a user response is expected, processor 121 may further instruct input module 124 to capture a user response, and cause the captured user response to be communicated to computing device 140 via communications module 125. This method is described in further detail below with reference to FIGS. 5 to 7.

Media device 130 may be an output device configured to play media to a user of system 100, in response to an interaction between the user and a component of system 100, such as sensor device 120, for example. Media device 130 comprises an output module 131 and a communications module 132. Output module 131 may comprise one or more output components, such as a visual screen display, speaker, light, buzzer or vibration motor. Communications module 132 may be configured to allow media device 130 to communicate with external devices such as computing device 140. Communications module 132 may be configured to facilitate communication via a wired or wireless communication protocol, which may include Bluetooth, Wi-Fi, Ethernet, USB, or another communication protocol.

In operation, when communications module 132 receives media data from computing device 140, media device 130 may be configured to cause output module 131 to play or display the media data. According to some embodiments, once the media has been played or displayed, media device 130 may be configured to cause communications module 132 to communicate this with computing device 140.

Computing device 140 may be a handheld computing device such as a smart phone, tablet, smart watch, personal digital assistant (PDA), or other handheld computing device. In some embodiments, computing device 140 may be a laptop computer, desktop computer, or server device. Computing device 140 may be used to facilitate an initial installation of ID tags 110, to allow a user to log on to system 100 with a user profile, and to facilitate the processing and delivery of interaction responses.

Computing device 140 comprises a processor 141 and a memory 143. Processor 141 may be configured to access data stored in memory 143, to execute instructions stored in memory 143, and to read and write data to and from memory 143. Processor 141 may comprise one or more microprocessors, central processing units (CPUs), application specific instruction set processors (ASIPs), or other processor capable of reading and executing instruction code.

Memory 143 may comprise one or more volatile or non-volatile memory types, such as RAM, ROM, EEPROM, or flash, for example. Memory 143 may store an application 144, such as an interactive learning application, configured to be executable by processor 141. When executed by processor 141, application 144 may be configured to cause computing device 140 to facilitate an interactive learning program with a subject. In particular, application 144 may cause computing device 140 to communicate with one or more of sensor device 120, media device 130 and cloud server 150 to determine interactions initiated by the subject, and to determine responses that should be returned to the subject, as described in further detail below.

Application 144 may also facilitate installation of ID tags 110 in an environment, by facilitating an installation mode. For example, processor 141 may be configured to execute application 144 to cause the computing device 140 to operate in an installation mode. When in the installation mode, computing device 140 may be configured to display the object or location type of an ID tag 110 scanned by sensor device 120, to allow the ID tags 110 to be installed in their correct locations.

Processor 141 may be configured to communicate with a communications module 142, which may be configured to computing device 140 to communicate with external devices such as sensor device 120, media device 130, and/or cloud server 150. Communications module 142 may be configured to facilitate communication via a wired or wireless communication protocol, which may include Bluetooth, Wi-Fi, Ethernet, USB, or another communication protocol.

Cloud server 150 may be cloud based distributed server system storing application code and data. Cloud server 150 comprises a communications module 152 to facilitate communication between cloud server 150 and/or computing device 140. Communications module 152 may be configured to facilitate communication via a wired or wireless communication protocol, which may include Bluetooth, Wi-Fi, Ethernet, USB, or another communication protocol.

Cloud server 150 stores a server application 151. Server application 151 may comprise executable program code, and may operate as a differentiation engine for decision making. Server application 151 may use artificial intelligence and computer learning to make decisions based on available data. In particular, server application 151 may be configured to receive user credential information, identification codes 115 and subject input data recorded by input module 124 from computing device 140, and to determine media data to be played to the subject via media device 130 in response.

Server application 151 may also draw on data other than that received from computing device 140 to inform its decision making. For example, server application 151 may retrieve data from a database 153, which may be stored in cloud server 150, to facilitate its decision making. Database 153 may store context based data points based on user interaction with system 100. For example, database 153 may store data points related to spatial and/or temporal aspects of a user's interaction with system 100, such as the location and/or time at which an interaction occurred. Database 153 may also store data points related to the frequency and/or latency of a user's interaction, such as data regarding when they last had an interaction, and/or how long it took a user to respond to an interaction by system 100. In some embodiments, database 153 may also record data regarding an identity of the user involved in the interaction, which may, for example, be based on user credentials used to login to the system 100. When cloud server 150 receives information regarding an interaction received by computing device 140, whether from tag sensor module 123 or input module 124, details of the interaction may be stored in database 153.

Server application 151 may also retrieve data from a cloud database 154 to facilitate decision making. Cloud database 154 may store search engine gathered data acquired to provide regional, environmental and cultural context to responses delivered by system 100. For example, cloud database 154 may determine and store information regarding where in the world computing device 140 is located, and/or cultural and/or regional information about the location of computing device 140, such as the dates of local holidays, items of local news, and local languages.

In operation, when cloud server 150 receives data relating to a user interaction via communications module 152, server application 151 retrieves relevant data from database 153 and from cloud database 154, and determines a response to be delivered to the user. The response is sent to computing device 140 via communications module 152 to be delivered by media device 130.

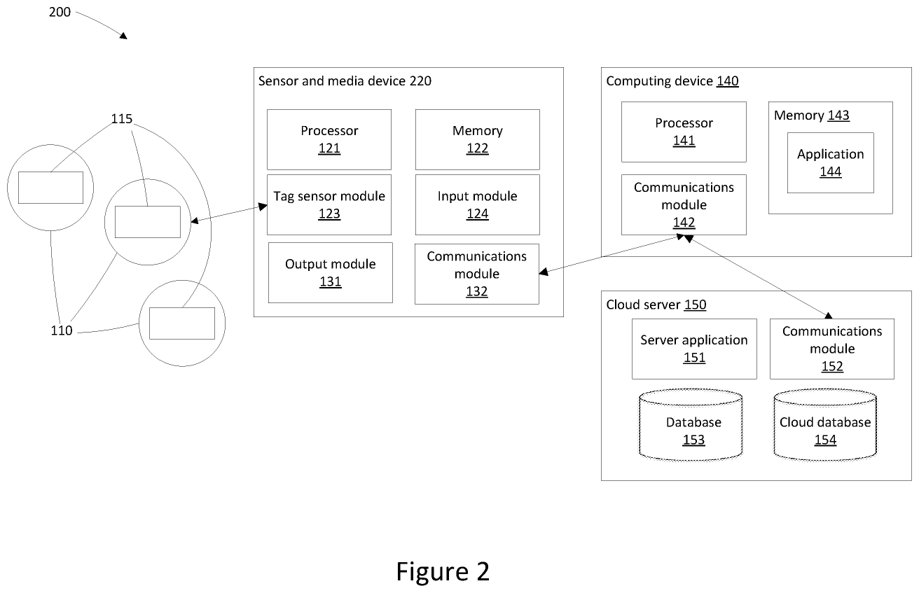

FIGS. 2 to 4 show alternative configurations of system 100.

FIG. 2 shows a system 200, having ID tags 110, a computing device 140 and a cloud server 150 as described above with reference to system 100 of FIG. 1. System 200 differs from system 100 in that system 200 comprises a combined sensor and media device 220.

Sensor and media device 220 comprises a processor 121 and memory 122, as described above with reference to FIG. 1. Processor 121 may be configured to access data stored in memory 122, to execute instructions stored in memory 122, and to read and write data to and from memory 122. Processor 121 may also be configured to communicate with one or more peripheral devices via one or more input and/or output modules, such as tag sensor module 123, input module 124, and communications module 125, as described above with reference to FIG. 1. Communications module 125 may be configured to allow sensor and media device 220 to communicate with external devices such as computing device 140.

Processor 121 may further be in communication with an output module 131. As described above with reference to FIG. 1, output module 131 may comprise one or more of a visual screen display, speaker, light, buzzer or vibration motor.

In use, when sensor and media device 220 comes into proximity with an ID tag 110, processor 121 may execute instruction code stored in memory 122 to cause processor 121 to instruct tag sensor module 123 to read identification code 115. Processor 121 may receive identification code 115 from tag sensor module 123, and communicate identification code 115 to computing device 140 via communications module 125. Communications module 125 is configured to receive response data from computing device 140. When response data is received, processor 121 causes output module 131 to play or display the media data. According to some embodiments, once the media has been played or displayed, processor 121 may be configured to cause communications module 125 to communicate this with computing device 140. If computing device 140 responds with a message to indicate that a user response is expected, processor 121 may further instruct input module 124 to capture a user response, and cause the captured user response to be communicated to computing device 140 via communications module 125.

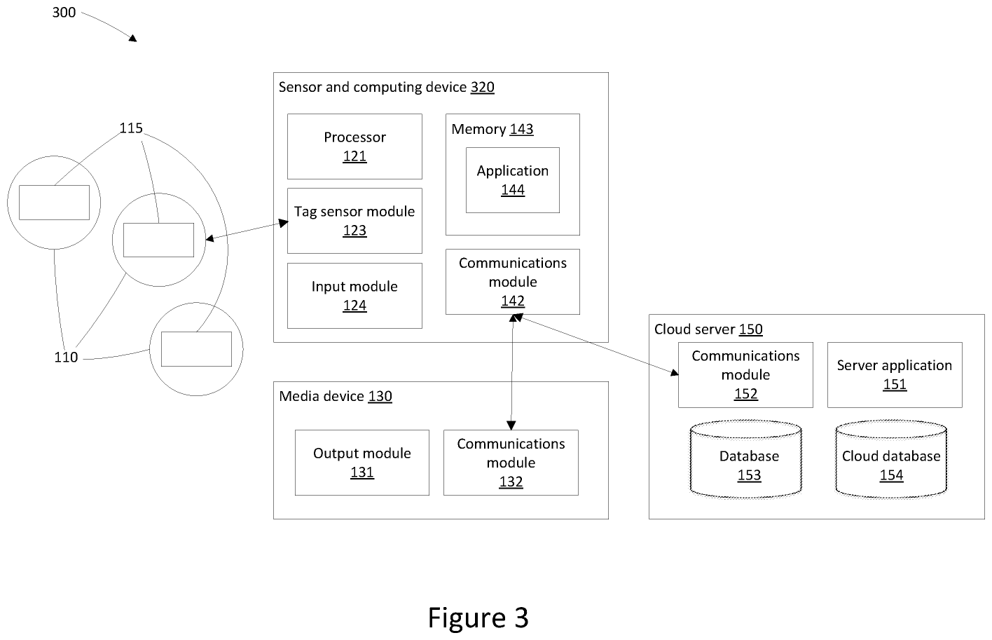

FIG. 3 shows a system 300, having ID tags 110, a media device 130 and a cloud server 150 as described above with reference to system 100 of FIG. 1. System 300 differs from system 100 in that system 300 comprises a combined sensor and computing device 320.

Sensor and computing device 320 comprises a processor 121, as described above with reference to FIG. 1. Sensor and computing device 320 further comprises memory 143 storing an application 144 configured to be executable by processor 121. Application 144 may be configured to cause computing device 140 to facilitate an interactive learning program with a subject, as described above with reference to FIG. 1.

Processor 121 may be configured to access data stored in memory 122, to execute application 144, and to read and write data to and from memory 122. Processor 121 may also be configured to communicate with one or more peripheral devices via one or more input and/or output modules, such as tag sensor module 123, input module 124, and communications module 125, as described above with reference to FIG. 1. Communications module 125 may be configured to allow sensor and computing device 320 to communicate with external devices such as media device 130 and cloud server 150.

In use, when sensor and device 220 comes into proximity with an ID tag 110, processor 121 may execute instruction code stored in memory 122 to cause processor 121 to instruct tag sensor module 123 to read identification code 115. Processor 121 may receive identification code 115 from tag sensor module 123, and communicate identification code 115 to cloud server 150 via communications module 125. Communications module 125 is configured to receive response data from cloud server 150. When response data is received, processor 121 causes communications module 125 to send the response data to media device 130 to be played to a user. According to some embodiments, once the media has been played or displayed, communications module 125 may receive a notification of this, and communicate the notification to cloud server 150. If cloud server 150 responds with a message to indicate that a user response is expected, processor 121 may further instruct input module 124 to capture a user response, and cause the captured user response to be communicated to cloud server 150 via communications module 125.

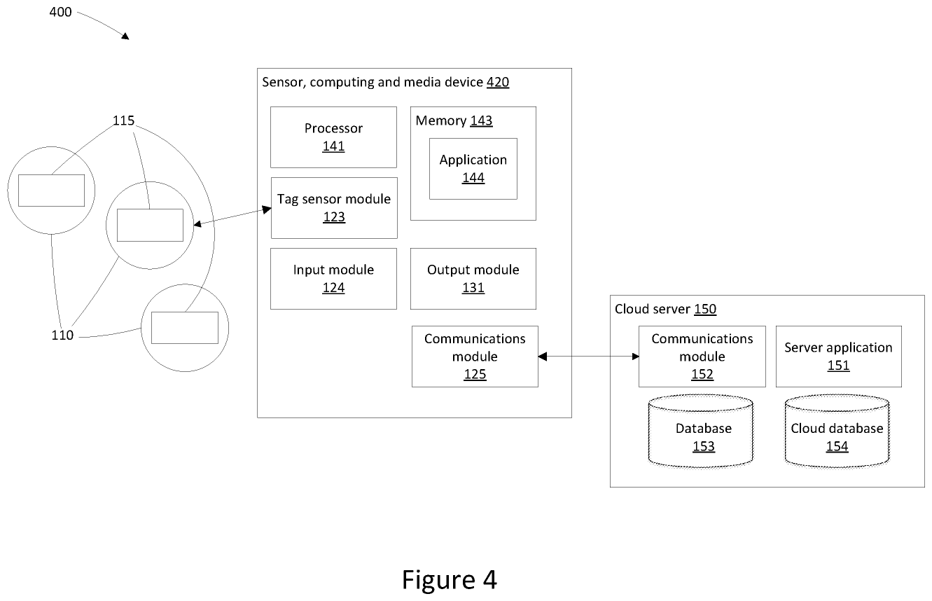

FIG. 4 shows a system 400, having ID tags 110 and a cloud server 150 as described above with reference to system 100 of FIG. 1. System 400 differs from system 100 in that system 400 comprises a combined sensor, media and computing device 420.

Sensor, media and computing device 420 comprises a processor 121, as described above with reference to FIG. 1. Sensor, media and computing device 420 further comprises memory 143 storing an application 144 configured to be executable by processor 121. Application 144 may be configured to cause computing device 140 to facilitate an interactive learning program with a subject, as described above with reference to FIG. 1.

Processor 121 may be configured to access data stored in memory 122, to execute application 144, and to read and write data to and from memory 122. Processor 121 may also be configured to communicate with one or more peripheral devices via one or more input and/or output modules, such as tag sensor module 123, input module 124, and communications module 125, as described above with reference to FIG. 1.

Communications module 125 may be configured to allow sensor and computing device 320 to communicate with external devices such as cloud server 150.

Processor 121 may further be in communication with an output module 131. As described above with reference to FIG. 1, output module 131 may comprise one or more of a visual screen display, speaker, light, buzzer or vibration motor.

In use, when sensor, media and computing device 420 comes into proximity with an ID tag 110, processor 121 may execute instruction code stored in memory 122 to cause processor 121 to instruct tag sensor module 123 to read identification code 115. Processor 121 may receive identification code 115 from tag sensor module 123, and communicate identification code 115 to cloud server 150 via communications module 125. Communications module 125 is configured to receive response data from cloud server 150. When response data is received, processor 121 causes output module 131 to play or display the media data. According to some embodiments, once the media has been played or displayed, processor 121 may be configured to cause communications module 125 to communicate this with cloud server 150. If cloud server 150 responds with a message to indicate that a user response is expected, processor 121 may further instruct input module 124 to capture a user response, and cause the captured user response to be communicated to cloud server 150 via communications module 125.

While FIGS. 5 to 7, as described in further detail below, refer to system 100 of FIG. 1, it is envisaged that corresponding methods and scenarios to those described with reference to FIGS. 5 to 7 would exist for systems 200, 300 and 400 of FIGS. 2, 3 and 4, respectively.

FIG. 5 shows a method 500 of facilitating an interactive learning process, as performed by computing device 140 of FIG. 1. In some embodiments, the processor 141 is configured to execute computer code associated with application 144 to cause the computing device 140 to carry out method 500.

At step 505 of method 500, computing device 140 receives user credentials input by a user during a login process, the user credentials being related to a user profile. Each user profile may have a related user level. In some embodiments, the user credentials may comprise one or more of a username, a password, an access code, a PIN code, or another form of user credential. User credentials may be input by a user using an input device associated with computing device 140, which may include a keyboard, mouse, touchscreen, or other input device.

In some embodiments, no login process is performed, and no user credentials are required to be entered. In particular, this may be the case where computing device 140 is a public device for use in a space such as a school or museum. In these cases, a general or default user profile having a generic or default user level may be used.

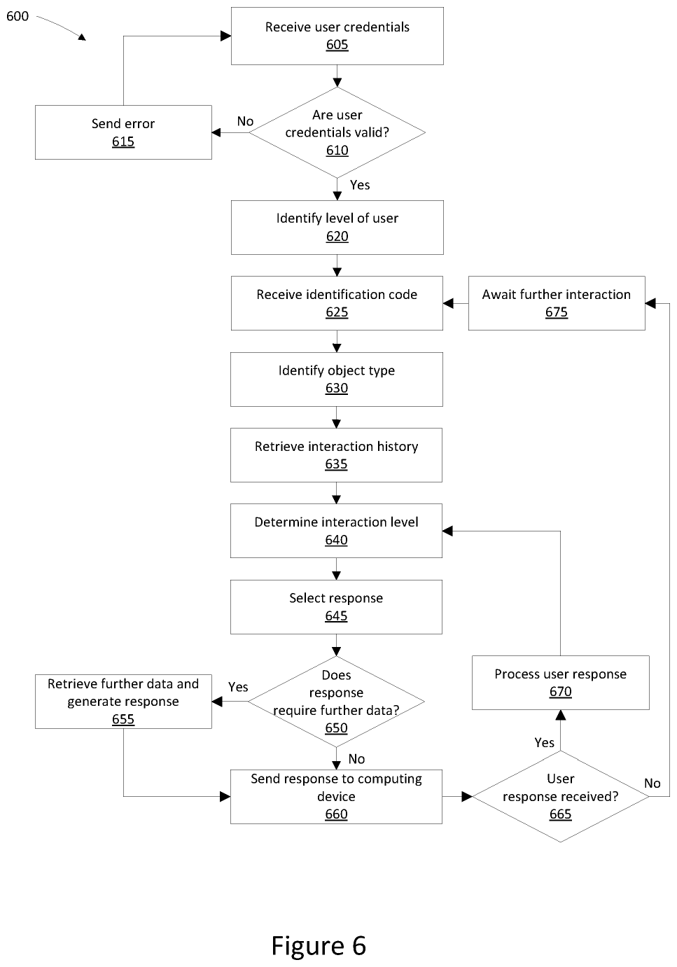

At step 510, if user credentials have been received, processor 141 executing application 144 causes communications module 142 to send the received user credentials to cloud server 150 for authentication, as described below with reference to steps 605 to 615 of FIG. 6. If a response from cloud server 150 indicates that the user credentials are not valid, at step 520 processor 141 causes an error to be displayed to the user of computing device 140. In some embodiments, processor 141 may further cause a prompt to be displayed to the user, instructing the user to re-enter their user credentials.

If the user credentials are found to be valid, for example, by receiving an indication from the cloud server 150, processor 141 executing application 144 causes the user to be logged on and awaits data from sensor device 120 indicating initiation of an interaction.

At step 525, data to indicate an initiation of an interaction is received. In the illustrated embodiment, an interaction can only be initiated by the user interacting with an ID tag 110, and so step 525 may comprise receiving data indicative of a user interaction with an ID tag 110. In some alternative embodiments, an interaction may also be initiated by the user providing a user input via input module 124, which may be by speaking into microphone, pressing a button, or typing on a keyboard, for example.

At step 530, processor 141 executing application 144 determines the identification code 115 received. In some embodiments, processor 141 may determine the identification code 115 by comparing data received with a list of identification codes stored in memory 143. In some embodiments, processor 141 may determine the identification code 115 by communicating with cloud server 150, which may store a list of identification codes within database 153.

At step 535, processor 141 executing application 144 sends identification code 115 to cloud server 150 for processing, as described below with references to FIGS. 625 to 675 of FIG. 6. At step 540, an output response is received from cloud server 150. At step 545, the output response received from cloud server 150 is communicated to media device 130 to be played or displayed to the user.

At step 550, processor 141 executing application 144 determines, based on communication with sensor device 120, whether a user response to the output response has been received. The user response may comprise a further interaction with ID tag 110, an interaction with a new ID tag 110, or a user input via user input module 124. If no further interaction is received, processor 141 causes method 500 to move to step 555, with computing device 140 awaiting a further signal from sensor device 120 to indicate a new interaction.

If a further interaction is received from sensor device 120 at step 550, processor 141 executing application 144 causes the new interaction to be sent to cloud server 150 by communications module 142 at step 560. Processor 141 then continues to execute method 500 from step 540, when a response from cloud server 150 is received.

FIG. 6 shows a method 600 of facilitating an interactive learning process, as performed by cloud server 150 of FIG. 1. In some embodiments, one or more processors associated of the cloud server 150 are configured to execute computer code associated with server application 151 to cause the cloud server 150 to carry out method 600.

At step 605, user credentials are received from computing device 140 via communications module 152. The user credentials may comprise one or more of a username, a password, an access code, a PIN code, or another form of user credential received by computing device 140 during a login process. As described above, in some embodiments, user credentials may not be required, in which case method 600 moves to step 620. At step 610, cloud server 150 executing server application 151 determines whether the received user credentials are valid. In some embodiments, this may be done by comparing the received credentials against credentials stored in database 153. If the credentials are found to be invalid, at step 615 cloud server 150 executing server application 151 sends an error response to computing device 140 via communications module 142.

If the credentials are valid, cloud server 150 may send a positive authentication response to computing device 140, and identify a user level for the logged on user profile at step 620. Levels for each user may be stored in database 153 and associated with each user account. In some embodiments, the higher the level of the user, the more difficult or sophisticated the responses delivered to the user by system 100.

At step 630, cloud server 150 receives an identification code 115 sent by computing device 140. At step 630, cloud server 150 executing server application 151 determines the object type associated with the identification code 115, by comparing identification code 115 with codes stored in database 153. In some embodiments, each identification code 115 may be associated with an everyday object or an area of an average home. For example, some identification code types may include window, door, table, chair, floor, bed, wall, kitchen, bedroom, and bathroom. In some embodiments, identification codes could be associated with other object types.

At step 635, cloud server 150 executing server application 151 may retrieve an interaction history for the logged in user from database 153. The interaction history may include data such as when the user last interacted with the current ID tag 110, when the user last interacted with any ID tag 110, and the level of user response received from the user based on a past interaction.

At step 640, cloud server 150 executing server application 151 may determine an interaction response level for a response to be delivered to the user. The interaction response level may be based on the user level identified at 620, as well as on the interaction history retrieved at step 635. According to some embodiments, the interaction response level may be based on the user level identified at 620, and modified based on the interaction history retrieved at step 635. For example, if a user level identified at step 620 is level 4, but the interaction history shows that the user has interacted with the current ID tag five times in the past 24 hours and has shown a level of user response indicating comprehension of the output responses delivered by system 100, at step 640 cloud server 150 may determine that the interaction response level for the present interaction should be delivered at level 5. If a user level identified at step 620 is level 4, but the interaction history shows that the user has not interacted with any ID tags in the past week, at step 640 cloud server 150 may determine that the interaction response level for the present interaction should be delivered at level 3. If a user level identified at step 620 is level 4, but the interaction history shows that the user has interacted with the current ID tag five times in the past 24 hours and has shown a low level of user response indicating low comprehension of the output responses delivered by system 100, at step 640 cloud server 150 may determine that the interaction response level for the present interaction should be delivered at level 3.

In some embodiments, once an interaction response level has been determined, this may be written to database 153 as a new user level. In some embodiments, the determined interaction response level may be a temporary interaction response level only, and may not change the user level.

At step 645, once an interaction response level has been determined, a response is selected by cloud server 150 executing server application 151. The response may be selected from a database of responses stored in database 153, and may be selected by the object type determined at step 630, and the interaction response level determined at step 640. For example, a level 3 response of object type “table” may be selected. In some embodiments, database 153 may store a plurality of possible responses for each object type and interaction response level. For example, database 153 may store ten possible level 3 responses for object type “table”. A response to deliver may be determined by cloud server 150 by selecting from the available responses at random, by cycling through the available responses in a predetermined sequence, or by selecting an appropriate response based on factors such as the date and time, interaction history, or other data. For example, according to some embodiments, if cloud server 150 determines that the present interaction is the first interaction of the day, and the time is before midday, cloud server 150 may select the response “Good morning!”.

At step 650, once a response has been selected, cloud server 150 executing server application 151 determines whether further data is required to complete the response selected at step 645. Further data may be required where a response includes variable fields. Variable fields may include a user's name, a date or time, the current weather, a user location, or another variable field. For example, a selected response may be of the form “It is [weather] today. Can you see the [weather object] outside?”. The variable fields are the day's current weather, which may be sunny, cloudy or rainy, and a weather object associated with the weather, such as the sun, the clouds or the rain.

If cloud server 150 executing server application 151 determines that a variable field requiring further data exists in the response selected at step 645, then at step 655, further appropriate data is retrieved to allow cloud server 150 to generate the complete response. Data may be retrieved from database 153, or from cloud database 154. Cloud database 154 may store data retrieved from the internet, such as local weather, holidays or special events for the given date, local languages and customs, and other data. Once the appropriate data is retrieved, the data is inserted into the response selected at step 645, and a complete response is generated. Cloud server 150 then moves to performing step 660.

If cloud server 150 executing server application 151 determines at step 650 that no variable field exist in the selected response, and that therefore no further data is require, cloud server 150 proceeds to perform step 660.

At step 660, cloud server 150 executing server application 151 sends the generated response to computing device 140 via communications module 152. At step 665, cloud server 150 determines whether a user response was received from computing device 140. If no response was received, cloud server 150 executes step 675, by awaiting further interaction data from computing device 140. If a response was received at step 665, the user response is processed by cloud server executing server application 151 at step 670.

The response received may be a further interaction with an ID tag 110, in which case processing the response at step 670 may include determining the identification code 115 of the ID tag 110 and identifying the associated object type, as described above with reference to step 630. The response may alternatively be a spoken response captured by a microphone, a typed response on a keyboard, a captured image on a camera, a touch screen selection of a response multiple choice answer, or another type of response recorded by input module 124 of sensor device 120. Processing the user response may involve performing speech recognition, comparing the received response with a set of predetermined possible responses stored in database 153, or using computer learning to identify the meaning of the response, in some embodiments.

Once the response has been processed, cloud server 150 may continue to execute method 600 from step 640.

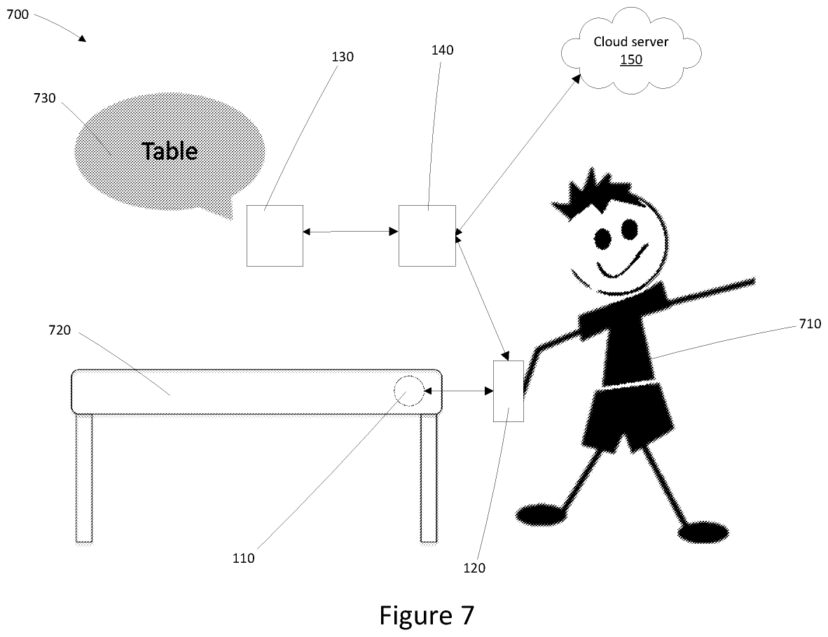

FIG. 7 shows an example scenario 700 illustrating use of system 100 by a user 710, according to the methods described above with reference to FIGS. 5 and 6.

User 710 brings a sensor device 120 into proximity with ID tag 110 attached to a table 720. Sensor device 120 reads identification code 115 on ID tag 110, and communicates this to computing device 140.

Computing device 140 sends the identification code 115 to cloud server 150, which determined that the identification code 115 is associated with a “table” object. Cloud server 150 further identifies, based on data retrieved from database 153, that the user logged in to system 100 is a level 1 user, and that the current interaction is the user's first interaction with ID tag 110 in the past 24 hours. Cloud server 150 executes server application 151, and determines that the response should be a level 1 response. Cloud server 150 selects a level 1 response corresponding to the “table” object type. The selected response is object name associated with the “table” object type, being the word “table”.

Cloud server 150 sends the response data to computing device 140, which forwards the response to media device 130. Media device 130 receives the response data, and communicates it to the user in the form of audio 130. User 710 hears media device 730 say the word “table”.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1-26. (canceled)

27. A computer implemented method of facilitating learning, the method comprising:
receiving, at a computing device, data indicative of a user profile, the user profile being associated with a user level;
receiving, at a computing device, data indicative of user interaction with an identification tag, wherein the data comprises an identification code;
identifying an object type associated with the identification code;
determining an interaction response level based on the user level associated with the user profile;
determining a response to be delivered to the user based on the object type and the interaction response level; and
causing the response to be delivered to the user.

28. The method of claim 27, wherein receiving data indicative of a user profile comprises receiving user credentials entered by a user during a login process.

29. The method of claim 27, wherein receiving data indicative of user interaction with an identification tag comprises receiving data from a sensor component of the computing device.

30. The method of claim 27, wherein receiving data indicative of user interaction with an identification tag comprises receiving data from a sensor device external to the computing device, the sensor device comprising a sensor component.

31. The method of claim 27, wherein causing the response to be delivered to the user comprises transmitting the response to the user from an output component of the computing device.

32. The method of claim 27, wherein causing the response to be delivered to the user comprises transmitting the response to an output device external to the computing device.

33. The method of claim 27, further comprising, before determining a response to be delivered to the user, modifying the interaction response level based on interaction history data retrieved from a database.

34. The method of claim 27, wherein the object type is identified based on matching the identification code to an identification code stored in a database of associated identification codes and object types.

35. The method of claim 27, further comprising:
identifying whether the response to be delivered includes a variable field; and
if the response to be delivered includes a variable field, retrieving appropriate data to insert into the variable field, to complete the response.

36. The method of claim 27, further comprising:
determining that a further interaction has occurred; and
generating a further response and causing the response to be delivered

37. The method of claim 36, wherein determining that a further interaction has occurred comprises receiving a signal from a sensor component of the computing device.

38. The method of claim 36, wherein determining that a further interaction has occurred comprises receiving a signal from a sensor device external to the computing device, the sensor device comprising a sensor component.

39. A computing device for facilitating learning, the computing device comprising:
a processor; and
memory accessible to the processor and storing executable code, wherein when the executable code is executed by the processor, the processor is caused to:
receive data indicative of a user profile, the user profile being associated with a user level;
receive data indicative of user interaction with an identification tag, wherein the data comprises an identification code;
identify an object type associated with the identification code;
determine an interaction response level based on the user level associated with the user profile;
determine a response to be delivered to the user based on the object type and the interaction response level; and
causing the response to be delivered to the user.

40. The computing device of claim 39, further comprising a communications module configured to facilitate communications between the computing device and at least one external device.

41. The computing device of claim 39, wherein the communications module is configured to facilitate communications between the computing device and a sensor device, and wherein the computing device is configured to receive data indicative of user interaction with the identification tag from the sensor device.

42. The computing device of claim 39, further comprising a tag sensor module, wherein the computing device is configured to receive data indicative of user interaction with the identification tag from the tag sensor module.

43. The computing device of claim 39, further comprising an output module, wherein the computing device causes the response to be delivered to the user by outputting the response via the output module.

44. The computing device of claim 40, wherein the communications module is configured to facilitate communications between the computing device and a media device, and wherein the computing device causes the response to be delivered to the user by communicating the response to the media device.

45. The computing device of claim 40, wherein the communications module is configured to facilitate communications between the computing device and a cloud server, and wherein the computing device determines a response to be delivered based on the object type and the interaction response level by communicating the object type and the interaction response level to the cloud server, and receiving a response to be delivered from the cloud server.

46. A kit for facilitating learning via interaction with objects in an environment; the kit comprising:
at least one identification tag comprising an identification code;
a sensor device configured to read the identification code of the at least one identification tag and communicate the identification code to a computing device; and
at least one media device configured to receive output media from the computing device and to deliver the output media to a user.
